(19) United States
(12) Patent Application Publication
(10) Pub. No.: US 2016/0277141 A1
(43) Pub. Date: Sep. 22, 2016

(54) Systems and Methods of Generalized DOCSIS Provisioning over Passive Optical Network

(71) Applicant: COX COMMUNICATIONS, INC., Atlanta, GA (US)

(72) Inventor: Yuxin Dai, Santa Rosa, CA (US)

(73) Assignee: COX COMMUNICATIONS, INC., Atlanta, GA (US)

(21) Appl. No.: 14/660,262

(22) Filed: Mar. 17, 2015

(51) Int. Cl. H04J 14/08; H04B 10/27

(52) U.S. Cl. CPC H04J 14/08; H04B 10/27

(57) ABSTRACT

In example embodiments of the systems and methods of generalized DOCSIS provisioning over Passive Optical Network disclosed herein, DOSCIS OSS management is mapped to TDM PON management via a DOCSIS Management Proxy (DMP). A DMP communicates with the TDM PON management plane as a proxy of the DOCSIS OSS management plane. In an example embodiment, DOCSIS services provisioning, Quality of Service (QOS), among other services are translated to the TDM PON management plane via DMP. The PON management plane then communicates to the PON control plane for both DOCSIS defined services and native TDM PON services such that resource conflicts are avoided and the PON optical layer fault management is supported. DMP is platform independent, as it applies to any TDM PON such as GPON, EPON, 10GEPON, and XGPON1, among others.

### TECHNICAL FIELD

The present disclosure is generally related to telecommunication and, more particularly, is related to passive optical network and cable systems.

### BACKGROUND

A Date Over Cable System Interface Specification (DOCSIS) Operation Support System (OSS) may be used by cable operators to provision services mostly to residential customers in Hybrid Fiber Coax (HFC) networks. DOCSIS Provisioning over Ethernet Passive Optical Network (EPON) (DPoE) has been proposed to provision services over EPON using DOCSIS OSS. DPoE uses Ethernet Operation and Management (OAM) extension to carry DOCSIS provisioning information across EPON system to provision Optical Network Units (ONTs). The idea of DPoE is to reuse DOCSIS OSS to prevision EPON services for business and residential customers. There are several limitations of the DPoE model.

First, since DPoE uses Ethernet OAM extensions for DOCSIS provisioning, the solution is limited to EPON. It is not easily extendable to other Time Division Mulitplex (TDM) Passive Optical Networks (PON) such as Gigabit Passive Optical Networks (GPON) that use ONT Management and Control Interface (OMCI) for provisioning and ONT management. One could use Ethernet OAM to replace OMCI, but by doing so will create a new GPON ONT eco system. Another solution for DOCSIS provisioning over GPON is to use OMCI to carry DOCSIS provisioning information. By doing so, not only may a new standard be needed to define DOCSIS provisioning over GPON (DPoG), but a new OMCI may be needed as well.

Second, in the DPoE model, the DOCSIS management plane directly communicates to the EPON control plane to provision DOCSIS defined services over EPON. However, EPON management, mainly Element Management System (EMS), is still needed for fault management of EPON optical layers, which have no support from DOCSIS OSS. As a result, both the EPON management plane and the DOCSIS management plane communicate to EPON control, and resource conflicts may occur.

Third, the implementation of DPoE or DPoG use new chip level Application Programming Interface (API) that will create a new type of ONTs. As a result, an isolated DPoE ONT or DPoG ONT island will appear out of the EPON or GPON eco systems. There are heretofore unaddressed needs with previous solutions.

### SUMMARY

Example embodiments of the present disclosure provide systems of generalized DOCSIS provisioning over Passive Optical Network. Briefly described, in architecture, one example embodiment of the system, among others, can be implemented as follows: a data over cable system interface specification (DOCSIS) management proxy, the management proxy configured to communicate between a time division multiplex (TDM) passive optical network (PON) network element management system and a DOCSIS operation support system (OSS) management system.

Embodiments of the present disclosure can also be viewed as providing methods for generalized DOCSIS provisioning over Passive Optical Network. In this regard, one embodiment of such a method, among others, can be broadly summarized by the following steps: receiving provisioning instructions from DOCSIS operation support system (OSS); and translating the provisioning instructions from DOCSIS OSS time division multiplex (TDM) passive optical network (PON) element management system (EMS) instructions to provision TDM PON.

### BRIEF DESCRIPTION OF THE DRAWINGS

FIG. 1 is a block diagram of DOCSIS provisioning over EPON (DPoE) from a management point of view.

FIG. 2 is a block diagram of an example DOCSIS provisioning over EPON implementation.

FIG. 3 is a block diagram of an example embodiment of a DOCSIS management proxy (DMP).

FIG. 4A is a block diagram of an example embodiment of DOCSIS provisioning over TDM EPON using the DMP of FIG. 3.

FIG. 4B is a block diagram of an example embodiment of DOCSIS provisioning over TDM GPON using the DMP of FIG. 3.

FIG. 5 is a block diagram of an example embodiment of an EMS and DMP implementation for generalized DOCSIS provisioning over Passive Optical Network.

FIG. 6 is a block diagram of an example embodiment of generalized DOCSIS provisioning over Passive Optical Network with the DMP embedded in the EMS server.

FIG. 7 is a block diagram of an example embodiment of generalized DOCSIS provisioning over Passive Optical Network with the DMP stored external to the EMS server.

FIG. 8 is a flow diagram of an example embodiment of a method of generalized DOCSIS provisioning over Passive Optical Network using the DMP of FIG. 3.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

In example embodiments of the systems and methods of generalized DOCSIS provisioning over Passive Optical Network disclosed herein, DOSCIS OSS management is mapped/translated to TDM PON management via a DOCSIS Management Proxy (DMP). A DMP communicates with the TDM PON management plane as a proxy of DOCSIS OSS. In an example embodiment, DOCSIS services provisioning, Quality of Service (QOS), among other services are translated to the TDM PON management plane via DMP. The TDM PON management plane then communicates to the TDM PON control plane for both DOCSIS defined services and native TDM PON services such that resource conflicts are avoided and the TDMPON optical layer fault management is supported. DMP is platform independent, as it applies to any TDM PON such as GPON, EPON, 10GEPON, and XGPON1, among others. Advantages include a universal provisioning method of DOCSIS for all TDM PONs; DMP for DOCSIS provisioning enabled EPON ONT or GPON ONT is maintained in the EPON or GPON eco systems; no new chip level APIs are needed; and it supports all native EPON or GPON management functions.

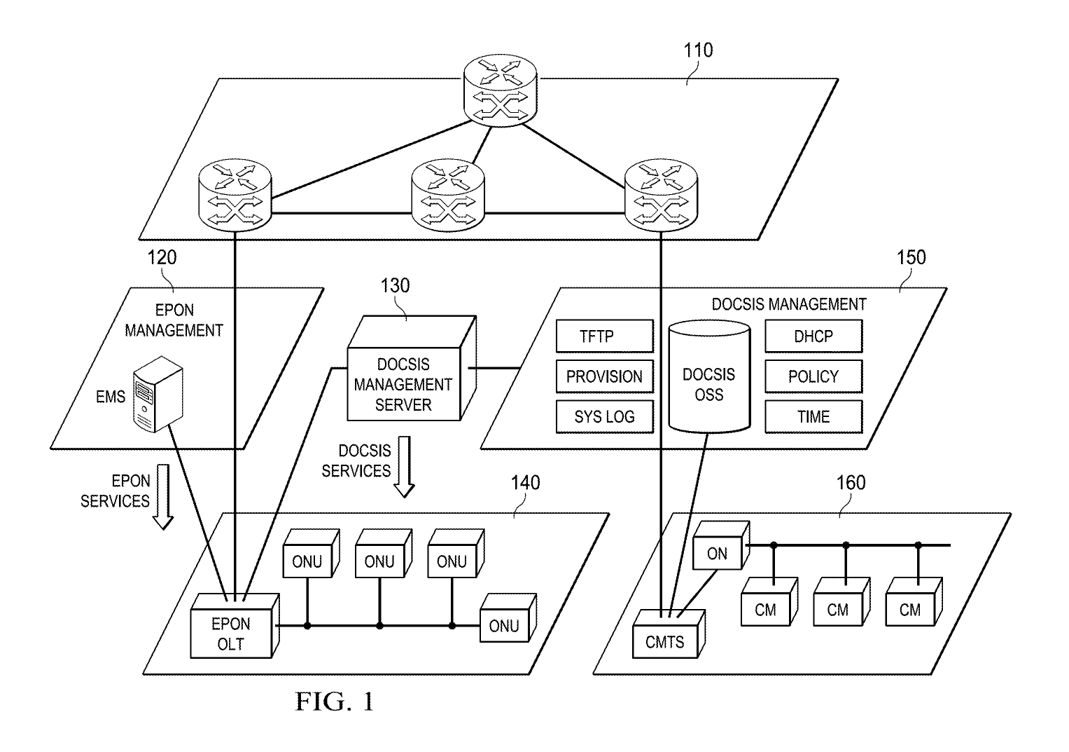

FIG. 1 provides an example embodiment of the DPoE from a management plane point of view. TDM PON such as EPON and GPON are provisioned and managed by management plane 120 via EMS (Element Management System) server 120. For example EPON is provisioned and managed via Ethernet OAM, and GPON is provisioned and managed by OMCI. In DPoE, DOCSIS provisioning instructions are translated by DOSCIS Management Server (DMS) 130 and are sent directly to EPON chip via a lower level API (Application Program Interface). EPON management plane 120 is not involved in DPoE process. Planes 140 and 160 are data planes.

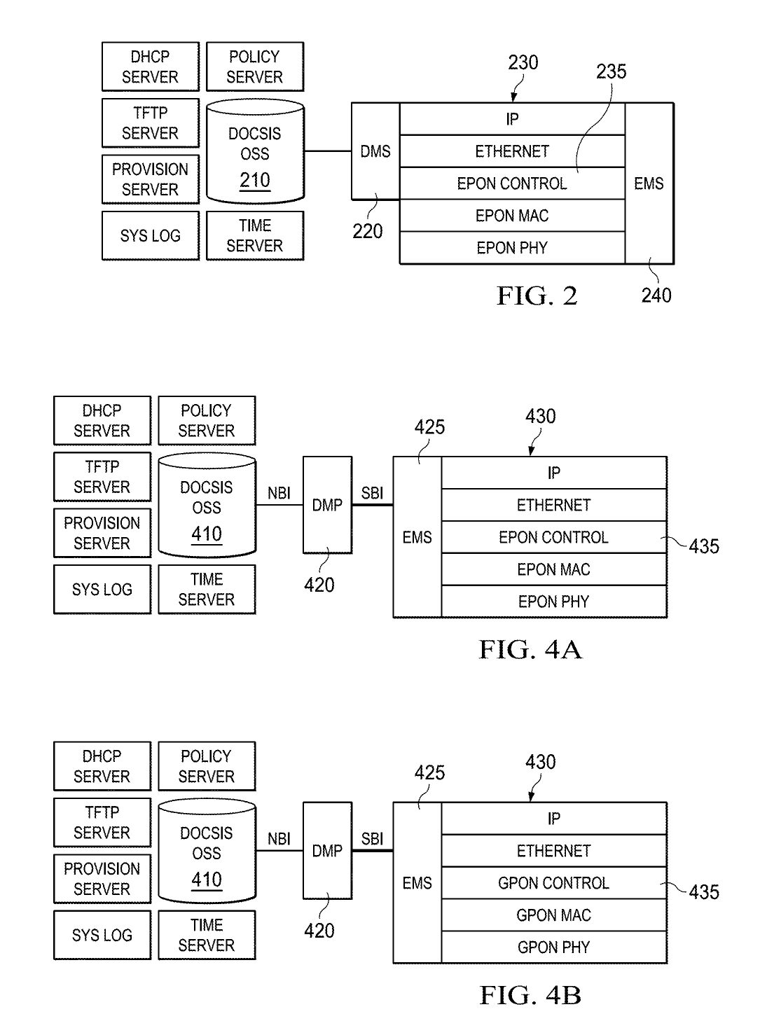

FIG. 2 provides a block diagram of an example implementation of DPoE. DMS 220 communicates to EPON control block 235 of EPON 230 via an API to provision DOCSIS defined services 210. For the services that are not defined in DOCSIS 210, the provisioning can be done in the normal way by EPON management plane via EMS 240. In DPoE implementation, DMS 220 simulates DOCSIS CMTS and communication at chip level that entangles control plane with management plane. This could cause resource conflict with EMS 240.

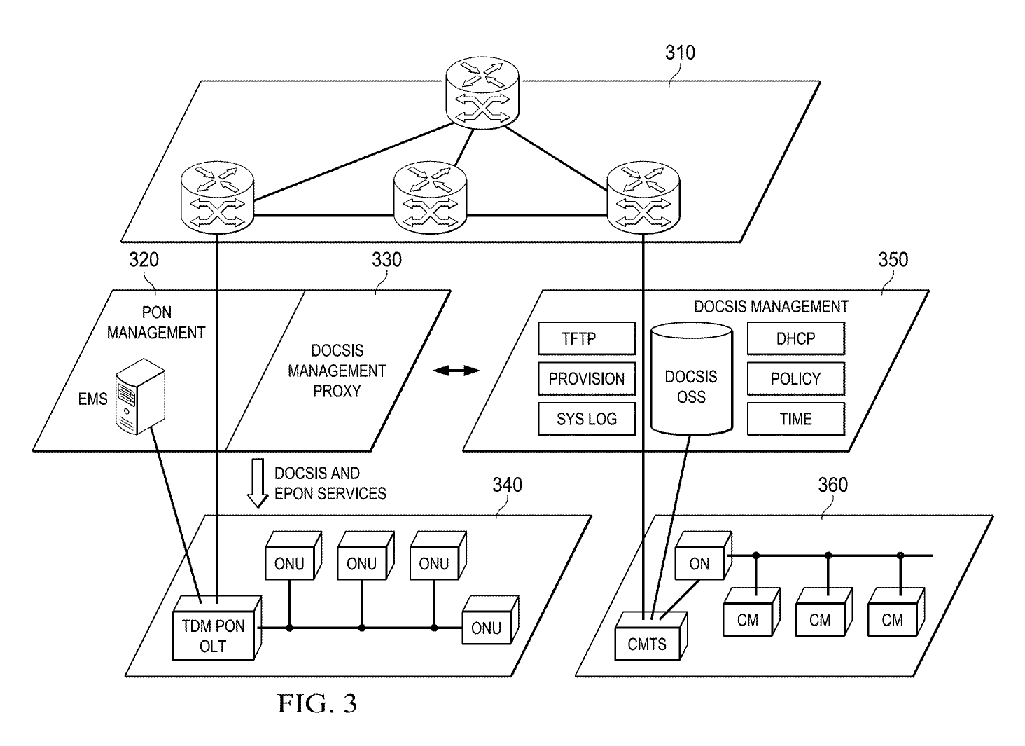

In an example embodiment of systems and methods of generalized DOCSIS Provisioning of TDM PON architecture as disclosed herein and provided in FIG. 3, DOCSIS Management Proxy (DMP) 330 is introduced to the TDM PON management plane. FIG. 3 shows DMP in an example generalized DOCSIS provisioning over Passive Optical Network architecture implementation. DMP 330 communicates with EPON EMS 320 at layer three (IP layer) instead of communicating with EPON control at lower chip lever via an API as in DPoE. DMP 330 translates DOCSIS OSS provisioning requests to the corresponding TDM PON provisioning to EMS 320, and EMS 320 then sets up the provisioning across the TDM PON system. DMP 330 is a proxy between DOCSIS management plane 350 and PON management plane 320. Metro network 310 feeds the access networks such as PON and CMTS. Planes 340 and 360 are data planes.

FIG. 4A provides an example embodiment of the system architecture of generalized DOCSIS provisioning over Passive Optical Network. Although EPON is used as an example, the same process is equally applicable to GPON as shown in FIG. 4B. DMP 420 communicates with EPON EMS 425 on behalf of DOCSIS OSS 410. The NBI (North Bound Interface) of DMP 420 may communicate with DOCSIS OSS 410 via TCP/IP and SBI (South Bound Interface) of DMP 420 may communicate with EPON EMS 425 via TCP/IP or UDP/IP depending on the detailed implementation of DMP 420. DPM 420 may act as a translation agent between DOCSIS OSS 410 and TDM PON EMS 425. DMP 420 may translate or map a DOCSIS provisioning request, QOS, bandwidth, etc. to TDM PON EMS 425 and EMS 425 then executes the provisioning. In an example embodiment, there is no direct communication between DMP and EPON control plane 435, resulting in a separation of the management planes and the control planes. In example embodiments of the systems and methods of generalized DOCSIS provisioning of TDM PON architecture provided herein, there are no changes to EPON OLT and ONT. Therefore, the problems of creating a new EPON ONT eco island may be avoided.

FIG. 4B provides an example embodiment of the system architecture of generalized DOCSIS provisioning over Passive Optical Network. DMP 420 communicates with GPON EMS 425 on behalf of DOCSIS OSS 410. The NBI (North Bound Interface) of DMP 420 may communicate with DOCSIS OSS 410 via TCP/IP and SBI (South Bound Interface) of DMP 420 may communicate with GPON EMS 425 via TCP/IP or UDP/IP depending on the detailed implementation of DMP 420. DPM 420 may act as a translation agent between DOCSIS OSS 410 and TDM PON EMS 425. DMP 420 may translate or map a DOCSIS provisioning request, QOS, bandwidth, etc. to GPON EMS 425 and EMS 425 then executes the provisioning. In an example embodiment, there is no direct communication between DMP and GPON control plane 435, resulting in a separation of the management planes and the control planes. In example embodiments of the systems and methods of generalized DOCSIS provisioning of PON architecture provided herein, there are no changes to GPON OLT and ONT. Therefore, the problems of creating a new GPON ONT eco island may be avoided.

Example embodiments of generalized DOCSIS provisioning over Passive Optical Network architecture disclosed herein are management layer solutions. The embodiments disclosed herein do not simulate a logical CMTS as in DPoE. Instead, the management plane is decoupled from the PON control plane. Therefore, it may be applied to all types of PON, such as EPON, 10G EPON, GPON, XGPON, NGPON2, and any PON standards of the future. The DMP allows seamless addition of new services, both supported by DOCSIS and not supported by DOCSIS.

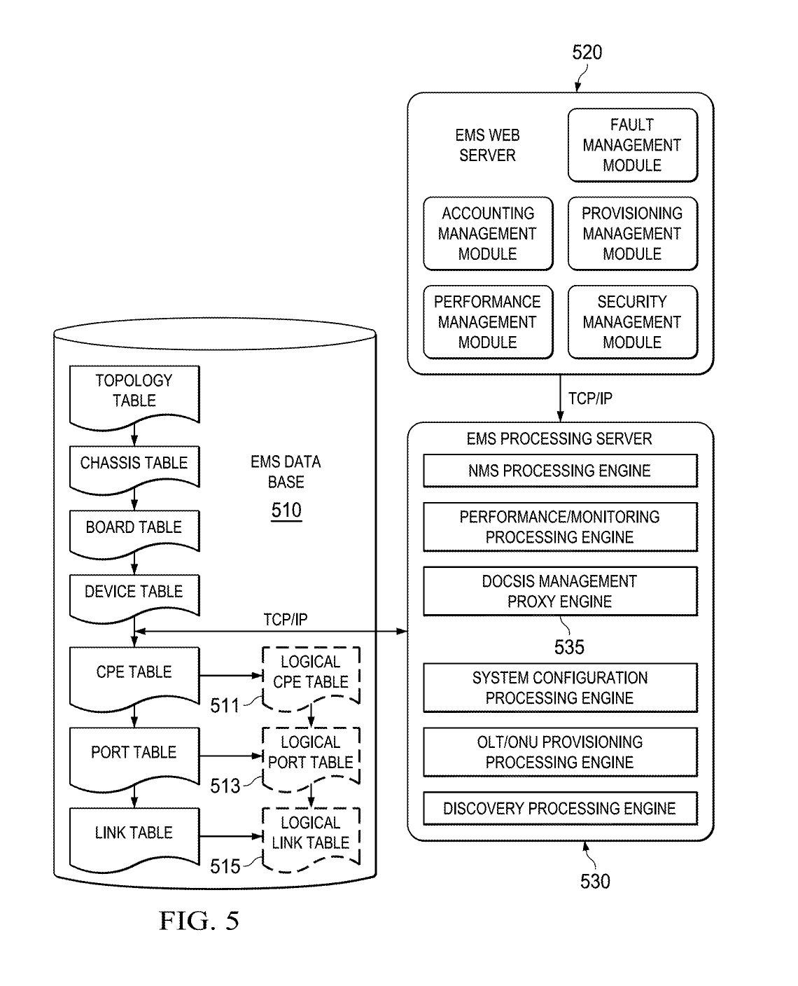

FIG. 5 provides an example embodiment of an EMS+DMP system implementation for generalized DOCSIS provisioning over Passive Optical Network. EMS database 510 contains the information tables on network topology, links, TDM PON systems (OLT chassis, board, ports, etc.), and CPE device (ONTs, gateways, etc.). The dotted lines of logical CPE Table 511, logical port table 513, and logical link table 515 indicate newly added tables corresponding to the DOCSIS Management Proxy function in EMS. Logical CPE table 511 is an image of ONT that is treated as a virtual Cable Modem (CM) by DOCSIS OSS. Logical port table 513 and logical link table 515 are images of the port and link to the virtual CM that correspond to DOCSIS OSS. These logical tables are part of the translation functions in DMP. DMP engine 525 is inserted in EMS process server 530 above the system configuration processing engine. DMP engine 525 communicates with DOCSIS OSS via NBI to get provisioning requests and with EMS data base 510 via TCP/IP to map the DOCSIS provisioning to TDM PON provisioning. After that it sends the request to the system configuration engine for processing. Beyond this point the processes are no different from the normal TDM PON EMS provisioning. EMS web server 520 is configured to support operation and management interface. The DMP could be integrated with TDM PON EMS as a module or it could be placed on an independent server. The DMP communicates with EMS via TCP/IP or UDP/IP depending on the implementation choices.

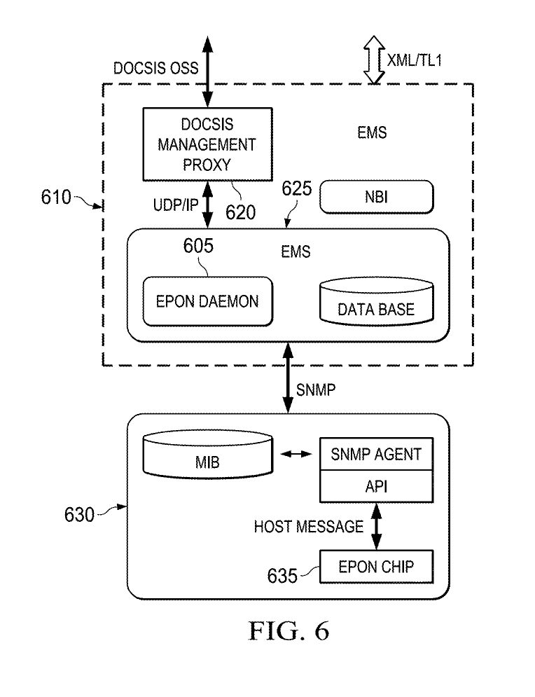

FIG. 6 provides a block diagram of an example embodiment of a system level implementation of the generalized DOCSIS provisioning over Passive Optical Network in which DOCSIS Management Proxy 620 is built into EMS server 610, an example embodiment of the EMS with an integrated DMP. In this integrated case, DMP 620 communicates with EMS 625 via UDP/IP protocols. DMP 620 could be implemented as an independent software module within EMS server 610. DMP 620 communicates with DOCSIS OSS system that could be located at another location through IP network via TPC/IP protocols. EPON Daemon 605 is a background software process running in EMS server 610 to control EPON systems. It may be replaced by “GPON Daemon” to control GPON systems in the same way. In an example embodiment, EMS 625 communicates with EPON (or GPON) OLT 630 via SNMP protocol. The provisioning instructions may be sent to EPON (or GPON) chip 635 via APIs. The MIB (Management Information Base) in PON OLT is for management purposes. The NBI of the EMS server may communicate with management network via XML or TL1 protocols. To clarify, EMS 625 is a traditional EMS and EMS 610 has an integrated DMP.

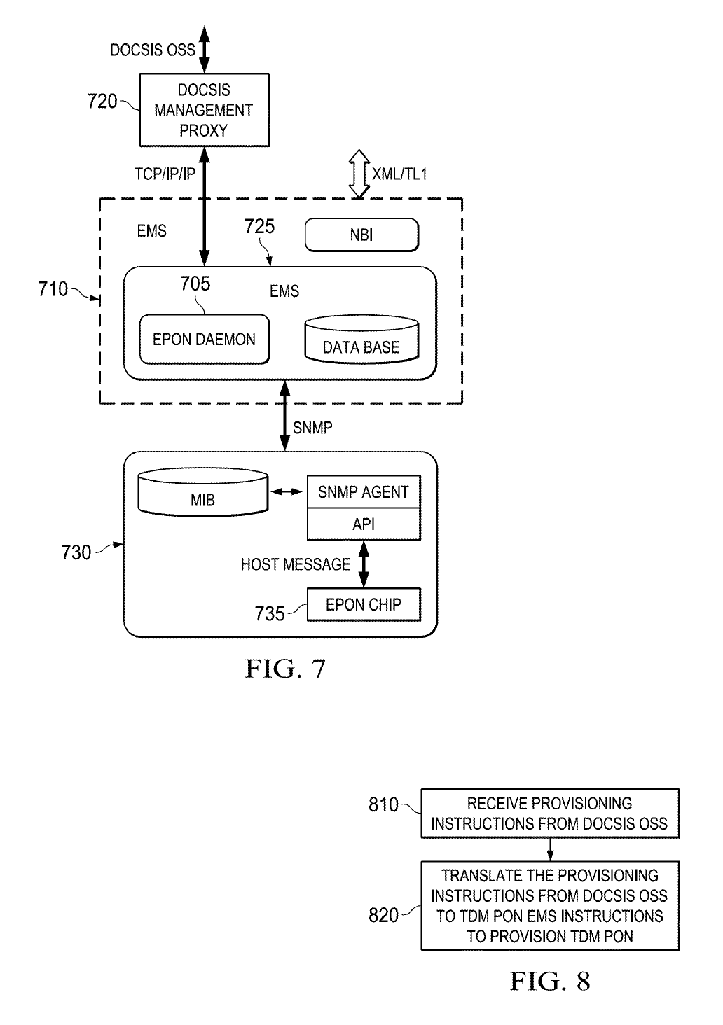

FIG. 7 provides a block diagram of an example embodiment of another system level implementation of the generalized DOCSIS provisioning over Passive Optical Network in which DOCSIS Management Proxy 720 is external to the EMS server 710. In this scenario, DMP 720 communicates with EMS 725 via TCP/IP protocols. DMP 720 communicates with DOCSIS OSS system that may be located at another location thought IP network via TPC/IP protocols. As with the example embodiment of FIG. 6, EPON Daemon 705 is a background software process running in EMS 725 to control EPON systems. It may be replaced by “GPON Daemon” to control GPON systems in the same way. EMS 725 communicates with EPON (or GPON) OLT 730 via SNMP protocol. The PON provisioning instructions may be sent to EPON (or GPON) chip 735 via APIs.

FIG. 8 provides a flow diagram of an example embodiment of a method of generalized DOCSIS provisioning over Passive Optical Network. In block 810, provisioning instructions are received from DOCSIS operation support system (OSS). In block 820, the provisioning instructions are translated from DOCSIS OSS to time division multiplex (TDM) passive optical network (PON) element management system (EMS) instructions to provision TDM PON.

The flow chart of FIG. 8 shows the architecture, functionality, and operation of a possible implementation of the digital isolation software. In this regard, each block represents a module, segment, or portion of code, which comprises one or more executable instructions for implementing the specified logical function(s). It should also be noted that in some alternative implementations, the functions noted in the blocks may occur out of the order noted in FIG. 8. For example, two blocks shown in succession in FIG. 8 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a software structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present disclosure has been described in detail, it should be understood that various changes, substitutions and alterations can be made thereto without departing from the spirit and scope of the disclosure as defined by the appended claims.

Therefore, at least the following is claimed:

1. A method of data over cable system interface specification (DOCSIS) management proxy (DMP) comprising:
receiving provisioning instructions from DOCSIS operation support system (OSS); and
translating the provisioning instructions from DOCSIS OSS to time division multiplex (TDM) passive optical network (PON) element management system (EMS) instructions to provision TDM PON.

2. The method of claim 1, further comprising provisioning the TDM PON system according to the DOCSIS provisioning instructions.

3. The method of claim 1, further comprising translating DOCSIS OSS provisioning instructions to TDM PON EMS provisioning instructions by a DMP

4. The method of claim 1, wherein the translating of DOCSIS provisioning to TDM PON provisioning is performed by a DOCSIS management proxy (DMP) stored in an EMS server.

5. The method of claim 4, wherein the translating of DOCSIS provisioning to TDM PON provisioning is performed by a DOCSIS management proxy (DMP) stored external to an EMS server.

6. The method of claim 1, further comprising receiving management/provisioning instructions from a DOCSIS OSS management plane and translating the management/provisioning instructions to a TDM PON management plane.

7. The method of claim 1, further comprising communicating by a DOCSIS management proxy engine with DOCSIS OSS to receive provisioning requests and with an EMS database to map the DOCSIS provisioning to TDM PON provisioning.

8. The method of claim 7, further comprising sending the provisioning requests by the DMP engine to a system configuration engine for processing.

9. A system, comprising:
a data over cable system interface specification (DOCSIS) management proxy, the management proxy configured to communicate between a time division multiplex (TDM) passive optical network (PON) network element management system and a DOCSIS operation support system (OSS) management system.

10. The system of claim 9, wherein the DOCSIS management proxy is further configured to translate provisioning requests from the DOCSIS OSS to TDM PON network element management system provisioning instructions for TDM PON.

11. The system of claim 10, wherein the TDM PON element management system provisions the TDM PON system with the provisioning requests from the DOCSIS OSS via the DOCSIS management proxy.

12. The system of claim 9, wherein the DOCSIS management proxy is located within a TDM PON element management system server.

13. The system of claim 9, wherein the DOCSIS management proxy is located external to a TDM PON element management system server.

14. The system of claim 9, further comprising a DOCSIS management proxy engine configured to communicate with DOCSIS OSS to receive provisioning requests and with an EMS database to map the DOCSIS provisioning to TDM PON provisioning.

15. A computer readable medium, comprising software with instructions for:
receiving provisioning instructions from a data over cable system interface specification (DOCSIS) operation support system (OSS);
translating the provisioning instructions from DOCSIS OSS to time division multiplex (TDM) passive optical network (PON) element management system (EMS); and
provisioning the TDM PON by the EMS.

16. The computer readable medium of claim 15, further comprising instructions for provisioning the TDM PON system according to the DOCSIS OSS provisioning instructions.

17. The computer readable medium of claim 15, wherein the instructions for translating the DOCSIS provisioning are performed by a DOCSIS management proxy (DMP) stored in an EMS server.

18. The computer readable medium of claim 17, wherein the instructions for translating the DOCSIS provisioning are performed by a DOCSIS management proxy (DMP) stored external to an EMS server.

19. The computer readable medium of claim 15, further comprising instructions for communicating by a DOCSIS management proxy engine with DOCSIS OSS to receive provisioning requests and with an EMS database to map the DOCSIS provisioning to TDM PON provisioning.

20. The computer readable medium of claim 19, further comprising instructions for sending the provisioning requests by the DMP engine to a system configuration engine for processing.
